(19) United States
(12) Patent Application Publication
(10) Pub. No.: US 2007/0116185 A1
(43) Pub. Date: May 24, 2007

(54) Real time web-based system to manage trouble tickets for efficient handling

(75) Inventors: Raj Savoor, Walnut Creek, CA (US); Baofeng Jiang, Pleasanton, CA (US); Xidong Wu, Livermore, CA (US); Mengfeng Tsai, Fremont, CA (US); Steve Sposato, Lafayette, CA (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/255,542

(22) Filed: Oct. 21, 2005

(51) Int. Cl. H04M 3/08

(52) U.S. Cl. 379/9

(57) ABSTRACT

A method of directing a trouble ticket includes receiving a trouble ticket via a web interface, characterizing the trouble ticket by group (i.e., assigning the trouble ticket to a group), and directing the trouble ticket to a maintenance center technician who is a specialist in the type of problems indicated by the group. The method may be performed by a computer system in response to a set of instructions stored on a computer-readable medium.

### BACKGROUND OF THE INVENTION

1. Field of the Invention

The present invention relates to the field of data management, and more specifically to efficient handling and management of a large number of trouble tickets associated with telecommunication services provided to customer.

2. Description of the Related Art

Trouble ticket management has traditionally involved several levels of expertise. Trouble tickets are generally created at a call center, which receives calls from customers. Each customer who encounters a problem typically notifies a call center established by the service providers by a telephone call, an email, or a web form that the customer is having trouble with a service, such as an Analog Digital Subscriber Line (ADSL), a cable TV service or another service or a product. The call center operator then generates a trouble ticket in response to the customer's notification.

Generally, the trouble tickets are entered into a mainframe computer system having a computer based file system. Each trouble ticket receives a unique trouble ticket number, and a single file is associated with each trouble ticket. The single file has a file name that includes the trouble ticket number. All attributes related to the trouble ticket, including the customer's phone number, address, time of reporting, customer narratives and symptoms, and related test data are all augmented together into the single file.

The single file is then sent to a maintenance center. At the maintenance center, files are usually placed into a queue. Each file receives a timestamp indicating when the file was entered into the queue. The queue may be regarded as a FIFO (first in, first out) queue, since files are typically selected for service in the order in which the files were placed in the queue. A maintenance center technician generally selects from the queue whichever file has an earliest timestamp. The maintenance center technician adds further test results, findings and narratives into the file. Thus, for the purpose of this disclosure a trouble ticket is information prepared or stored in a database that indicates that a service or product does not or may not meet one or more criteria or parameter for such a service or product.

The file is sometimes referred to as a “trouble ticket narrative log” and the system may be known as a trouble ticket work flow application or system. Maintenance center technicians (also referenced as users) have traditionally used graphical user interfaces (GUIs) to access the files in a command prompt-response format. Upon receiving a user-issued command from a maintenance center technician, a server coupled to the trouble ticket work flow application retrieves the file relating to a trouble ticket, such as the trouble ticket in the queue that has an oldest timestamp. The file is presented, in its entirety, to the maintenance center technician, who reads and analyzes the file and draws a conclusion based on the maintenance center technician's experience.

Often, such files may include contradictory and/or unclear information, since multiple individuals may have participated in its creation. The files may contain narratives from different technicians at different time points. Moreover, each file is usually handled individually, despite possible similarities among files resulting from a common problem. Descriptions of problems may be subjective, using different terms to describe a problem that is shared among several trouble tickets. The present invention addresses some of the above-noted problems and provides a web-based system for tracking and managing trouble tickets.

### SUMMARY OF THE INVENTION

In accordance with one aspect of the present invention, a method of directing a trouble ticket comprises receiving a trouble ticket via a web interface, characterizing the trouble ticket by group, assigning the trouble ticket to a group, and directing the trouble ticket in accordance with the characterization. The method may be performed by a computer system or by a network of computer systems interconnected over the Internet or within a local network. The network of computer systems may be wired or wireless, and may be implemented using a client/server model, a peer-to-peer model, or other model. One or more of the computer systems may have a memory that contains a computer-readable medium having a set of instructions operative to cause the computer system to execute the method of directing a trouble ticket and comprises receiving a trouble ticket via a web interface, characterizing the trouble ticket by group, assigning the trouble ticket to a group, and directing the trouble ticket to a specialist in accordance with the characterization.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, reference should be made to the following detailed description of an exemplary embodiment, taken in conjunction with the accompanying drawings, in which like elements have been given like numerals.

FIG. 1 depicts a exemplary, non-limiting, schematic illustration of a web-based trouble ticket tracking and management system according to one non-limiting exemplary embodiment of the present invention.

FIG. 2 is a flowchart depicting an exemplary, non-limiting method of directing and managing trouble tickets, in accordance with one embodiment of the present invention.

FIG. 3 is a sample of one of many possible screens showing results from an expert system that has processed DSL trouble tickets.

### DETAILED DESCRIPTION OF THE INVENTION

In view of the above, the present invention through one or more of its various aspects and/or embodiments is presented to provide one or more advantages, such as those noted below.

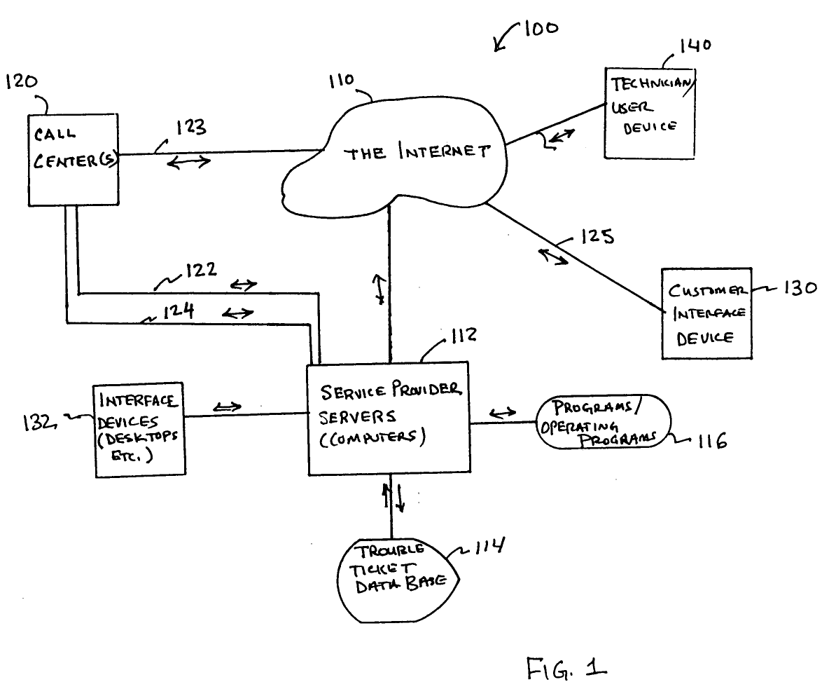

FIG. 1 shows a web-based trouble ticket tracking and management system 100 according to a non-limiting exemplary embodiment of the present invention. The system 100 shows internet 110 that may be utilized to implement the system 100. The system 100 may include one or more computers or servers 112 that may further include the necessary peripherals, including memory devices, display devices, etc. for storing information, presenting information and to perform other associated functions. The system 100 provides a database structure 114 that includes fields and parameters relating to trouble tickets as described in more detail below. Programs, including operating programs 116 are provided and are accessible to the computers 112 which execute instructions contained in the programs 116 to receive trouble ticket information or data, organize trouble tickets, track trouble tickets, apply business rules to categorize the trouble tickets, provide reports, visual displays and to perform other actions and compute results contemplated in the invention and described in this disclosure. The system 100 includes one or more call centers, such as a call center 120, that may accept calls from customers, such as DSL customers, Cable TV customers, etc. of a service provider, such as the assignee of this application. The system 100 also provides that customers utilizing a suitable interface, such as (GUI) Graphical User Interface 130 may communicate with the system via the web or the internet 110. The customer GUI 130 may include a computer, a mobile personal device, such as a PDA or a telephone. Service provider personnel, such as technician may interface with the trouble ticket information using a GUI's 140 via the internet (line 125) or a cellular network.

A customer, may call a call center 120 and provide verbal input to a call center operator about the problem the customer is experiencing with the service, such as the DSL service. The call center operator then may enter data on a trouble ticket specific to the customer calling and send it to the servers or computers 112 via dedicated connections or lines 122, a wireless network 124 or via the internet 110 (connection or lines 123). In the alternative and/or in addition to the call center entering the trouble ticket data, the customer may download a blank trouble ticket (i.e. a form) prescribed by the service provider from a specified website and enter the trouble related data using the customer interface 130 via the internet (line 125). The customer may enter data, such as customer DSL line number (telephone number), address, type of trouble, comments pertinent to the trouble, and the type of the hardware and/or programs being utilized by the customer. The customer, in one aspect of this invention, may be allowed to tap into a server or other products of the service provider to perform tests on the customer DSL line or account.

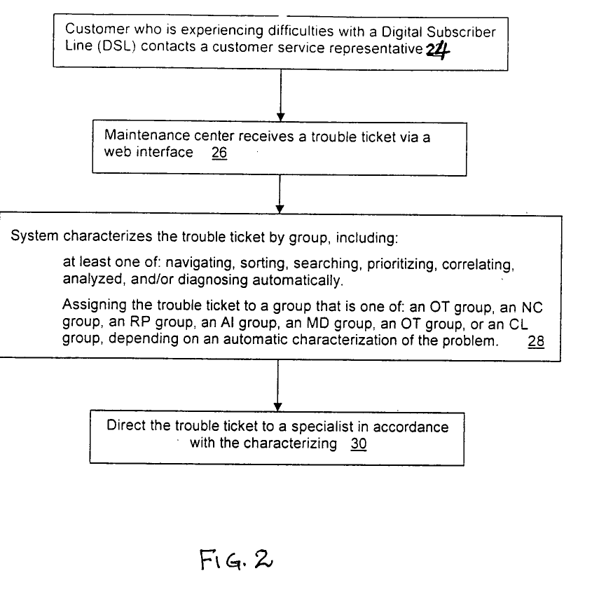

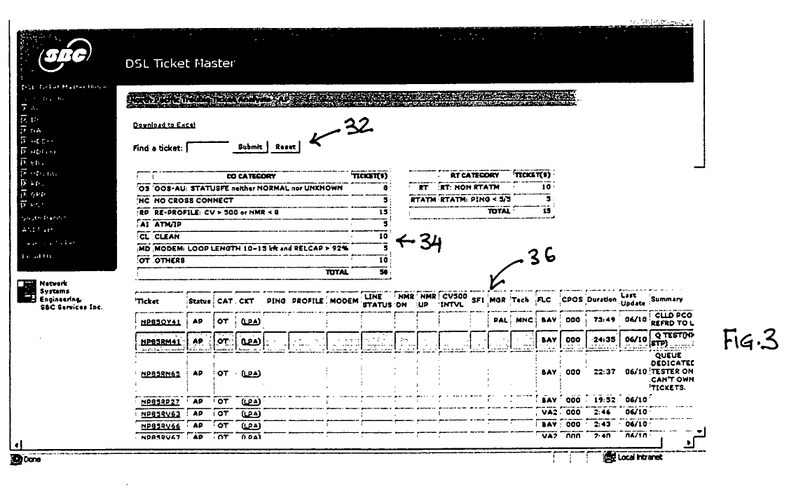

Still referring to FIG. 1, the computers or servers 112 execute the program 116 and provide trouble ticket reports that may include, without limitation, a report that groups the trouble tickets according to assigned groups or trouble types that may include: a common group in geographical areas or segments, a group according to the type of trouble, or assign them in a queue in the order the trouble tickets were entered into the database. A user, typically a technician, may download one or more of the reports, or the next trouble ticket in queue via a graphical user interface device (GUI) 140, which may be any suitable device, including a PDA, a mobile phone, or a portable computer via the internet 110. Other service provider personnel, such as management or supervisory personnel, may access any information relating to the trouble tickets via a desk top computer 132 or any other suitable device. A method that utilizes the system, such as the system 100, is described in more detail below with respect to FIGS. 2 and 3.

FIG. 2 is a flowchart depicting a method of directing and managing trouble tickets, in accordance with one embodiment of the present invention. Initially, a customer who is experiencing difficulties with a service, such as a Digital Subscriber Line (DSL), or a cable TV may contact a customer service representative (block 24). As noted above, the customer may contact the customer service representative via a telephone call, via email, via a web link or form, or via some other mode or technology. Even if the customer is unable to contact the customer service representative via the DSL, due to the difficulties that the customer may be experiencing, the customer may be able to contact the customer service representative via a web connection provided by a nearby wireless access point or by a web-enabled personal data assistant (PDA). The customer service representative may be located at a call center, where a large number of customers may be serviced simultaneously.

The customer service representative may have limited knowledge and experience about the underlying service, and may be unable to assist the customer to the customer's satisfaction. If the customer requires additional help to resolve the difficulties, then the customer service representative may access a web page and create a trouble ticket. The web page may be, for example, on an internal intranet or on the Internet. The web page may be encrypted, and may belong to a virtual private network (VPN). The customer service representative may obtain information from the customer verbally, or may initiate an automatic system for testing for obtaining information from the Digital Subscriber Line of the customer.

The trouble ticket may be assigned a unique trouble ticket number, and have a single file that may be created on a computer system corresponding to the trouble ticket. The unique trouble ticket number may be used as a file name of the single file. The single file may be collected with other single files corresponding to other trouble tickets, and be a part of a data base such as database 114 (see FIG. 1) that may reside on a mainframe computer system such as servers 112 (see FIG. 1). In other words, a mainframe computer based file system may compile data for trouble ticket tracking and management.

Information obtained from the customer, regardless of whether the information is obtained automatically or verbally or through some other technique, may be included within the trouble ticket. The trouble ticket may have a customer's name, phone number, address, any narrative and description of any symptoms that the customer may proffer, a time of reporting, any narrative and description of any symptoms that the customer service representative may proffer, any test data, and/or other data that may be accumulated by the customer call center. As the trouble ticket is accessed by other persons, including technicians (which persons also are referred to herein as users or end users), each person may append additional notes to the trouble ticket, and any such notes are added to the single file which also is referred to as a trouble ticket narrative log.

In one aspect, the single files may reside on several computer systems, such as a collection of computer systems or servers in a local area network (LAN). The single files may also reside on a large number of computer systems distributed in location, such as a Wide Area Network (WAN) implementing a VPN. Within a VPN, each transmission of data or information may be automatically encrypted as the transmission enters the network from a source computer system, and may be automatically decrypted as the transmission is received by a destination computer system from network. The encryption used by the source computer system may be such that only the destination computer system has a corresponding decryption key, and only performed “in the background” such that no user of either computer system is aware that encryption is being used.

The mainframe computer system need not be modified to implement the method depicted in FIG. 2. In other words, the mainframe computer system may continue to use a legacy file management system, and a legacy trouble ticket system, without modification. The term legacy is used to generally mean an “existing” hardware, software or a combination thereof. For example, the mainframe computer system may continue to use the trouble ticket work flow application, and may continue to store each trouble ticket as a trouble ticket narrative file or log. In accordance with the method depicted in FIG. 2, however, the single files are made available over the Internet.

A customer service wizard may also be provided to allow the customer to create a trouble ticket automatically, over a web page. The customer may access a web page that allows the customer to enter data into the single file directly. For example, the customer may be able to enter a description of the difficulties that the user has been experiencing, the address at which the customer has been experiencing the difficulties, a duration of the difficulties, a number of times the difficulties have been experienced, and/or other information that the customer is able to provide. The customer may also use a graphical user interface (GUI) to initiate tests that automatically collect additional information directly from the network and that the customer may not personally be able to describe. For example, equipment such as a trunk line may be tested in response to the customer's clicks. Once the trouble ticket is generated, the trouble ticket may be received (block 26) via a web interface. For example, the trouble ticket is received from the call center via the web interface.

In the system of FIG. 2 any suitable graphical user interface (GUI) including, a legacy GUI may be used. The trouble tickets that are received (from the call center or via the web interface or entered via another mechanism) may be regarded being in a queue, also known as a FIFO (First In First Out) queue. A service technician may access a trouble ticket in the queue. Specifically, the service technician may access an oldest-in-queue trouble ticket, also known as a first-received trouble ticket, and may attempt to resolve the difficulties that are described in the oldest-in-queue trouble ticket. The service technician may use a legacy or another GUI to click on and view any trouble ticket. The service technician may use a text editor to read the information that has been collected from the customer, and may send the trouble ticket on for further processing.

However, in one aspect of the invention, the trouble tickets may be characterized (block 28) and assigned to groups. The trouble ticket (which may be a bulk ticket) may be navigated, sorted, searched, prioritized, correlated, analyzed, and/or diagnosed automatically according to one or more rules or business criteria programmed or stored in a computer of the system as an operating program, such a programs 116 (FIG. 1). In one aspect, the trouble ticket may be automatically assigned to a group of trouble tickets, such that a common problem or a parameter is shared among all trouble tickets within the group. Each group is assigned an identifier or a group identifier. For example, each group may be identified by a two-letter designation. Specifically, in one aspect, the trouble ticket may be assigned to an OT group, an NC group, an RP group, an AI group, an MD group, an OT group, or an CL group, depending on an automatic characterization of the problem as described in more detail below.

The trouble ticket (and the corresponding file) may be assigned to the OS group if the problem is an Out of Service (OS) problem, to the NC group if the problem is a No Cross Connect (NC) problem, or to the RP group if the problem is a Re-Profile problem. Re-Profile problems may include problems that relate to one or more performance criteria or limits set for the various components or service aspects in the system. For example, a maximum bit rate, an impulse noise limit for a line or a noise margin ratio or another system element health related parameter. If a trouble ticket indicates that one or more such parameters are outside a limit or threshold, the such a trouble ticket may be categorized as a reprofile group. When the number of trouble tickets for a particular reprofile problem (also referred to as a code violation) exceed a certain number, the computers in one aspect may automatically look at the set performance criteria or thresholds being violated and apply recommendations utilizing programmed rules or instructions without a maintenance personnel or manual intervention. In one aspect, the system may change the threshold to a new threshold and update the related trouble tickets to show that the problem has been resolved, thereby clearing the trouble. In another aspect, the system may first verify that the new threshold does not or will not degrade the service before clearing the tickets. In another aspect, the system may call for a corrective action to upgrade or repair the affected equipment or lines do that a large number of the reprofile group trouble tickets may be disposed of substantially simultaneously. In another aspect, the trouble tickets (and the corresponding file) may be assigned to the Al group if the problem is an Asynchronous Transfer Mode (ATM)/Internet Protocol (IP) problem, to the MD group if the problem is a Modem problem, or to the OT group if the problem is any other problem. The trouble tickets (and the corresponding files) may be assigned to the CL group if the problem has been resolved (i.e., the line is clear). The trouble tickets may also be assigned a group or subgroup designation based on the geographical regions, for example served by a particular group of technicians, in a neighborhood, a zip code, etc. Thus, in general, in the system of the invention may be categorize trouble tickets into any number of suitable groups or may utilize other parameters or designations and categorize the trouble tickets. Other parameters and the tickets according to those designations.

Characterizing the trouble tickets may include an expert system that may operate at a business object layer and/or a web-based presentation layer above a data layer on a mainframe. For example, the expert system may be a rule-based system operative to use rule-based business logic to categorize the trouble ticket and to group similar tickets. The web-based presentation layer may present statistical information or bulk information about the trouble tickets, and need not present each trouble ticket individually. Accordingly, solutions may be implemented that can resolve many trouble tickets collectively. For example, the expert system may also include a loop performance analyzer (LPA) that can be used in a bulk process to analyze DSL lines of many customers in one operation. Such a solution may not be readily apparent from a queue approach to trouble ticket management, particularly when a large number of service technicians access the queue, since trouble tickets having a common solution may be accessed by distinct service technicians.

The web-based presentation layer, however, may make large-scale solutions apparent. The service technicians may use any software or program, including any commercially available web-based presentation software to generate histograms, pie charts, and bar graphs, to understand where repair efforts may be most effective. Such abstract web-based presentations of large numbers of trouble tickets may not be apparent to service technicians who access trouble tickets via a queue.

The expert system may be configured such that each group is governed by a rule. Each trouble ticket is assigned to a group upon a determination that the trouble ticket complies with the rule. The rule may be executed upon the data contained within the single file corresponding to the trouble ticket, and the data contained within the single file may be organized to facilitate application of the rule. If a trouble ticket complies with the rule, then the trouble ticket is assigned to the group corresponding to the rule.

The expert system also may be configured such that each group is governed by many rules. Boolean or other logical combinations of rules may be used to assign the trouble tickets to groups. Each trouble ticket is assigned to a group upon a determination that the trouble ticket complies with the rules of the group. For example, a first group may be defined to include only trouble tickets indicating a “line-out” problem in a particular city (e.g., Oakland, Calif.), and a second group may be defined to include only trouble tickets that indicate an operating system problem. If a trouble ticket complies with the rule, then the trouble ticket is assigned to the group corresponding to the rule. The first group may then be advantageously accessed by a field service repair technician in the particular city, and the second group may be advantageously accessed by a software expert planning to deploy software to customer sites.

The maintenance center technician may also be able to initiate new rules within the rule-based system. A GUI may be available to allow the maintenance center technician to apply each new rule to many groups at once, based on electrical measurements, inside wiring types, modem type, or other characteristics of the communication system. The maintenance center technician may be provided with a graphical user interface that allows the maintenance center technician to enter a rule generation command. In response to the rule generation command, a rule may be applied to one or more groups.

The characterizing may also be operative to append a diagnosis to each trouble ticket. The diagnosis may include an objective conclusion on a root cause, recommending a possible solution for the trouble ticket. The diagnosis may also identify contradictory data and root cause for the contradictory data.

Each trouble ticket that has been characterized into a group is then directed (block 30) to a maintenance center department, where maintenance center technicians who specialize in a particular category of problems may access trouble tickets that relate to a particular problem. The maintenance center technicians need not be limited by any timestamp or time-in-queue restrictions. In other words, the categorizing of the trouble tickets by group, rather than by time/date, may also allow each maintenance center technician to specialize in a particular type of problem.

Within the maintenance center department, additional web-based presentation layer software may be used to analyze the trouble tickets that have been assigned to the group. For example, a first maintenance center department responsible for resolving operating system problems may wish to segregate multi-user customers from single-user customers, a second maintenance center department responsible for visiting customer sites may wish to segregate customers by zip code or by trunk line, a third maintenance center department responsible for solving modem problems may wish to segregate customers by modem type, and a fourth maintenance center may not regard such segregations as useful at all. Accordingly, each maintenance center department may use web-based presentation layer software that is most helpful and appropriate to understanding and solving problems indicated in the trouble tickets assigned to the group.

The categorizing of the trouble tickets by group utilizing business rules, rather than by time/date, may also allow each maintenance center technician to recognize large-scale problems and solutions more easily. For example, if many customers located in a common geographical region or if many customers that have a particular type of modem all share a common problem, the maintenance center technician may be better able to notice a commonality of problems described in the trouble tickets. If the maintenance center technician ascertains (based on customer addresses) that many customers have an Out of Service problem (i.e. no service of a particular type), the maintenance center technician may be able to determine where a line has been damaged. If a problem can be resolved using a bulk repair process, the maintenance center technician can initiate the bulk process.

The maintenance center technician may be better able to request a bulk repair, in response to a group of trouble tickets. For example, if several customers near one another require a particular service, a field repair technician may be assigned to go to each customer site to effect repairs in one field service call. If many problems can be resolved by replacing a line, then the maintenance center technician may be able to request that the line be replaced. Not only may large problems be more easily noticed when the maintenance center technician is able to observe many trouble tickets having a common problem, but solutions may be more easily implemented.

Accordingly, a web-based communication system between the call center and the maintenance center allows the maintenance center to access trouble tickets using a web-based connection; an expert system, which implements a business objects layer, automates handling of incoming trouble tickets; and a web-based presentation layer allows service technicians at the maintenance center to organize and plan maintenance operations more efficiently.

FIG. 3 is an exemplary, nonlimiting, sample screen showing results from an expert system that has processed DSL trouble tickets. The sample screen may be regarded as a web-based presentation layer, and the expert system may be regarded as a business object layer.

The sample screen includes a search feature 32 that allows a maintenance center technician to search the WFA to find a particular trouble ticket. The sample screen also includes a trouble ticket summary table 34 identifying each category (or group) to which trouble tickets may be assigned, and a count of the number of trouble tickets that have been assigned to each category.

The sample screen also includes a report 36 having a record for each trouble ticket. Each trouble ticket has been generated by a call center in response to a communication from a customer. Each record of the report has at least one field; the fields in the report 336 of FIG. 3 include: a trouble ticket identifier, status indicator, a category indicator, a circuit indicator, a ping indicator, a profile indicator, a modem type, a line status, a noise margin ratio down-line from the customer, a noise margin ratio up-line from the customer, a signal frequency 1 indicator, manager initials, technician initials, a floor controller indicator, a customer position operating system indicator, a call duration, a date of last update, and a notes summary.

The method depicted in FIG. 2, and the generation of the report depicted in FIG. 3, may be accomplished by software that is stored in a computer-readable medium. The computer-readable medium may have a set of instructions operative to cause a computer to execute the method and other functions described herein.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A system comprising:
a processor;
a computer readable medium accessible to the processor;
a computer program embedded in the computer readable medium, the computer program comprising:
instructions to access a data base having a plurality of trouble tickets, each trouble ticket in the plurality of trouble tickets having a field for a type of trouble in a communication network;
instructions to categorize the trouble tickets in the plurality of trouble tickets into at least one predefined group; and
instructions to provide access to the trouble tickets in the plurality of trouble tickets by the at least one categorized group.

2. The system of claim 1 further comprising:
instructions to categorize the trouble tickets in the plurality of trouble tickets into a reprofile group when the type of trouble indicates that a parameter of the communication network is outside a threshold; and
releasing trouble associated with the trouble tickets in the profile group based on a business rule.

3. The system of claim 2 wherein the business rule is a rule that allows a system to alter the threshold to a level that will cause at least some of the trouble tickets in the reprofile group to fall within the altered threshold.

4. The system of claim 1 wherein the computer program further comprises instructions to provide the trouble tickets in the plurality of trouble tickets according to the categorization over the internet.

5. The system of claim 1 wherein the computer program further comprises instructions that enable transfer of information relating to the trouble tickets in the plurality of trouble tickets between a mobile device system.

6. The system of claim 1 wherein the at least one group includes a plurality of groups selected from a set consisting of groups based on: zip code, geographical region, neighborhood, out of service, code violation, no cross-connect, customer equipment problem, resolved problems, and internet protocol problem.

7. The system of claim 1 further comprising a historical data base relating to problems with elements of the communication network and wherein the computer program further comprises instructions to utilize the historical data to categorize the trouble tickets in the plurality of trouble tickets.

8. A method of managing a plurality of trouble tickets, comprising:
receiving the trouble tickets in the plurality of trouble tickets via a web interface; characterizing each trouble ticket in the plurality of trouble tickets into a group selected from a set of groups; and
directing the trouble tickets in the plurality of trouble tickets for use by a user in accordance with the characterizing over the internet.

9. The method of claim 8 wherein the characterizing includes imposing at least one rule-based business logic that comprises at least one of navigating, sorting, searching, prioritizing, correlating, analyzing, and diagnosing of trouble tickets.

10. The method of claim 8 wherein the characterizing of the trouble ticket includes categorizing into a group selected from a set of groups consisting of:
an OS group if a problem associated with the trouble ticket is an Out of Service (OS) problem; an NC group if the problem associated with the trouble ticket is a No Cross Connect (NC) problem; an RP group if a problem associated with the trouble ticket is a Re-Profile problem; an AI group if a problem associated with the trouble tickets is an Asynchronous Transfer Mode (ATM)/Internet Protocol (IP) problem; an MD group if a problem is associated with the trouble ticket is a Modem problem; an OT group if a problem associated with the trouble ticket is a problem that falls outside a specified set of groups; and a CL group if a problem associated with the trouble tickets has been resolved.

11. The method of claim 8 further comprising:
generating a report having a record for each trouble ticket corresponding to a customer, each record of the report having at least one field selected from a group consisting of: a trouble ticket identifier, a status indicator, a category indicator, a circuit indicator, a ping indicator, a profile indicator, a modem type, a line status, a noise margin ratio down-line from the customer, a noise margin ratio up-line from the customer, a signal frequency indicator, manager's initials, technician's initials, a floor controller indicator, a customer position operating system indicator, a call duration, a date of last update, and a notes summary.

12. The method of claim 8 wherein the categorizing includes utilizing a rule-based system operative to use a rule-based business logic to categorize the trouble tickets in the plurality of trouble tickets and to group tickets having at least one common characteristic into a common group.

13. The method of claim 8 further comprises utilizing a loop performance analyzer (LPA) to categorize the trouble tickets in the plurality of trouble tickets.

14. The method of claim 8 further comprising receiving data relating to the trouble tickets in the plurality of trouble tickets from a graphical user interface that utilizes a rule generation command and providing to the graphical user interface the trouble tickets according to the categorization.

15. The method of claim 8 wherein categorizing includes performing a step selected from a group consisting of: diagnosing, drawing an objective conclusion on a root cause, recommending a solution for a trouble ticket, and identifying contradictory data relating to a trouble ticket and root cause for the contradictory data.

16. A computer-readable medium having a set of instructions operative to cause a computer to execute a method, the method comprising:
receiving a trouble ticket via a web interface;
characterizing the trouble ticket by group, including assigning the trouble ticket to a group; and
directing the trouble ticket to a user in accordance with the characterizing.

17. The computer-readable medium of claim 16 wherein the characterizing includes at least one of navigating, sorting, searching, prioritizing, correlating, analyzing, and diagnosing of trouble tickets, including bulk tickets.

18. The computer-readable medium of claim 16 wherein the characterizing includes an expert system operative to operate at a business object and web-based presentation layer above a data layer on a mainframe, wherein the expert system is a rule-based system operative to use rule-based business logic to categorize the trouble ticket and to group similar tickets.

19. The computer-readable medium of claim 16, wherein:
the characterizing includes assigning at least one rule to at least one group such that the trouble ticket is not assigned to the at least one group unless the trouble ticket complies with the at least one rule; and
the characterizing is operative to perform at least one of: diagnosing, drawing an objective conclusion on a root cause, recommending a solution for the trouble ticket, and identifying contradictory data relating to a trouble ticket and a root cause for the contradictory data.

20. The system of claim 1 further comprising a plurality of portable devices adapted to input data into the data base and to receive trouble ticket information and at least one server adapted to initiate generation of trouble tickets in the plurality of trouble tickets.
